(19) United States
(12) Patent Application Publication
(10) Pub. No.: US 2010/0070169 A1
(43) Pub. Date: Mar. 18, 2010

(54) Method of advertising using waypoints

(76) Inventors: Matthew Paulin, Seattle, WA (US); Ryan Smits, Seattle, WA (US); Adam Hindman, Seattle, WA (US); Willeam R. Levering, III, Seattle, WA (US); Matthew Francis, Seattle, WA (US)

Correspondence Address: Gerhard P. Shipley, 300 Clayton Court, Lawrence, KS, 66044, US

(21) Appl. No.: 12/283,667

(22) Filed: Sep. 15, 2008

(51) Int. Cl. G01C 21/00; G06Q 30/00

(52) U.S. Cl. 701/206; 705/14.58

(57) ABSTRACT

A method of doing business in which a Service Provider grants to organizations rights to waypoints to which users may travel and view the organizations' messages. The method may include the steps of granting to the organization the right to the waypoint, receiving from the organization a message to be associated with the waypoint, storing the waypoint and the message in a database, allowing for bi-directional data communication with a mobile device which is able to determine its own location, receiving from the device an indication that the device is at or near the waypoint, and automatically causing the device to display the message when the device is at or near the waypoint.

### FIELD OF THE INVENTION

The present invention relates to methods of advertising using waypoints. More specifically, the present invention concerns a method of doing business wherein a Service Provider leases, sells, e.g., auctions, or otherwise grants to businesses or other organizations rights to geographic locations, i.e., waypoints, to which users may travel and view the organizations' advertising or other messages.

### BACKGROUND OF THE INVENTION

It is often desirable for businesses to advertise to potential customers. To that end, many businesses display signs at or near their physical locations. Unfortunately, signs are sometimes obstructed from view, sometimes by other signs, and therefore not always effective. Furthermore, it is sometimes not possible to display a sign, such as where laws or regulations do not permit doing so or where the density of businesses is so high that there is insufficient space to do so. Additionally, it can be difficult to measure the advertising effectiveness of physical signs. For example, businesses may purchase space on billboards, but have no way of knowing how many potential customers see the billboards, and therefore no way of knowing the actual value of their advertising.

Many potential customers now carry or have in their vehicles devices which are operable both to access the Internet and to determine and display their geographic locations. This allows potential customers to first search for and learn about businesses of interest via the Internet, and then quickly and easily navigate to the physical locations of the businesses.

### SUMMARY OF THE INVENTION

The present invention overcomes the above-identified and other problems and disadvantages by providing a method of doing business wherein a Service Provider leases, sells, e.g., auctions, or otherwise grants to businesses or other organizations rights to geographic locations, i.e., waypoints, to which users may travel and view the organizations' advertising or other messages.

In one embodiment, the method may comprise the steps of granting to an organization a right to a waypoint, wherein the waypoint is associated with a particular geographic location; receiving from the organization a message to be associated with the waypoint; storing the waypoint and the message in a database of waypoints and messages; allowing for bi-directional data communication with a mobile device which is operable to determine its own geographic location; receiving from the mobile device an indication that the device is at or near the particular geographic location associated with the waypoint; and substantially automatically causing the device to display the message when the device is at or near the particular geographic location associated with the waypoint.

In various implementations, the method may further include any one or more of the following features. The right to the waypoint may be granted via a leasing or sale arrangement. The sale arrangement may involve an auction process, with the highest bidding organization winning the right to the waypoint. The device may be a cell phone operable to use a global positioning system to determine its own geographic location. The method may further include the step of charging the business a fee for each device on which the advertisement is caused to be displayed. The device may be substantially automatically caused to display the message when the device is within a particular number of feet from the particular geographic location of the waypoint. The method may further include the step of providing a hyperlink to additional information about the organization or the particular geographic location associated with the waypoint. The method may further include the step of rewarding a user of the device for traveling to the waypoint. The method may further include the step of assigning one or more points to the user for traveling to the waypoint, and maintaining point totals for all such users, thereby facilitating competition among the users to travel to more waypoints. The method may further include the step of providing each user with a webpage on which to communicate the user's point total.

An exemplary application of the method may comprise the steps of auctioning to a business an advertising right to a waypoint, wherein the waypoint is associated with a particular geographic location; receiving from the business an advertisement to be associated with the waypoint; storing the waypoint and the advertisement in a database of waypoints and advertisements; allowing for bi-directional data communication with a mobile device which is operable to determine its own geographic location; receiving from the mobile device an indication that the device is at or near the particular geographic location associated with the waypoint; and substantially automatically causing the device to display the advertisement when the device is at or near the particular geographic location associated with the waypoint.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, which are not necessarily to scale:

FIG. 1 is a flowchart of steps in an embodiment of the method of the present invention; and

FIG. 2 is a flowchart of steps in an exemplary application of the method.

### DETAILED DESCRIPTION OF THE INVENTION

With reference to the drawing figures, a method is herein described, shown, and otherwise disclosed in accordance with various embodiments, including a preferred embodiment, of the present invention.

Broadly, the present invention concerns a method of doing business wherein a Service Provider leases, sells, e.g., auctions, or otherwise grants to businesses or other organizations rights to geographic locations, i.e., waypoints, to which users, or Participants, may travel and view the organizations' advertising or other messages. Each Participant carries or is otherwise associated with an electronic device operable both to determine the device's geographic location, using, e.g., global positioning system (GPS) technology, and to wirelessly access a data communication network, such as the Internet. The Service Provider maintains a database of waypoints and one or more advertisements or other messages associated with each waypoint, and is able to communicate via the network with the Participants' devices to substantially automatically display the messages when a display condition occurs, such as the Participant arriving at the waypoint or requesting information about the waypoint.

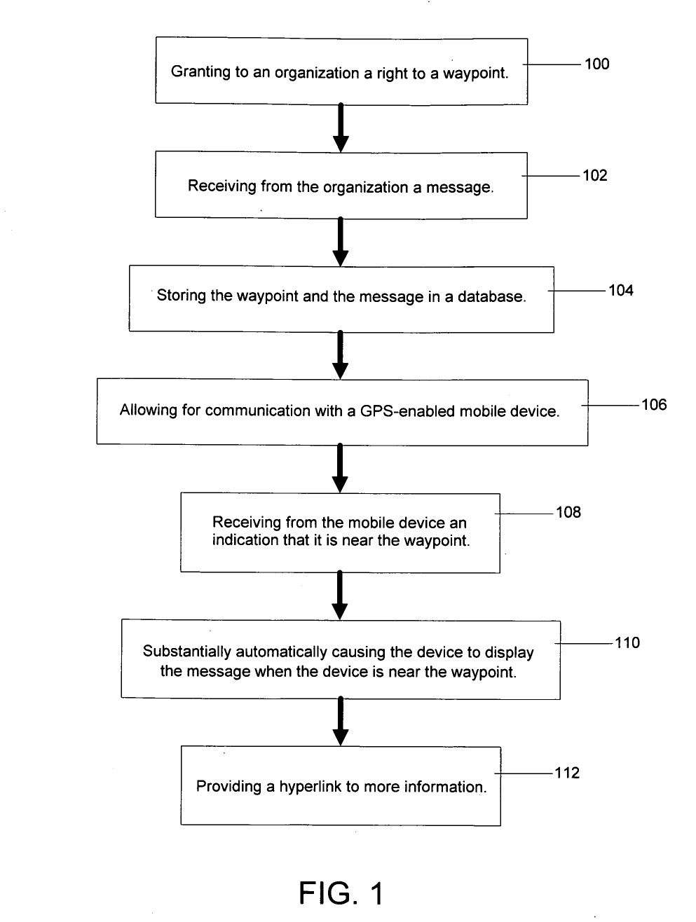

More specifically, with reference to FIG. 1, in one embodiment the method may comprise the following steps. The Service Provider leases, sells, or otherwise grants to the business or other organization a right to a waypoint, wherein the waypoint is associated with a particular geographic location, as shown in box 100. For example, the right may be sold via an auction process, wherein the right is granted to the highest bidder.

Given general accuracy limitations on determining geographic location, and the prevalence in some locales of very high business density, only one or a very few prime waypoints may exist for any given business. Prime waypoints may include, for example, a sidewalk or street location proximate to a business or an entrance to a building in which the business is located. Prime waypoints may also include locations that are physical remote from the business' location, but still associated in some way thereto. For example, a prime waypoint for a business that sells mountain climbing equipment might be the summit of a mountain. As such, advertising associated with prime waypoints may be of significant value to businesses.

The Service Provider receives from the organization an advertisement or other message to be associated with the waypoint, as shown in box 102. The Service Provider stores the waypoint and the message in a database of waypoints and messages, as shown in box 104.

The Service Provider allows for bi-directional data communication with a portable or otherwise mobile location-determining device which is carried by the Participant, as shown in box 106. The bi-directional data communication may be via a wireless network, such as the Internet.

The Service Provider receives from the Participant's device an indication that the device is at or near the location associated with the waypoint, as shown in box 108. The Service Provider substantially automatically causes the device to display the message when a display condition occurs, as shown in box 110. The display condition may be that the Participant's device is within a specific distance, e.g., a number of feet, from the location of the waypoint, or the display condition may be that that the Service Provider receives a request for information about the location from the Participant.

The method may further include the step of providing a hyperlink to additional information about the organization or the location, as shown in box 112.

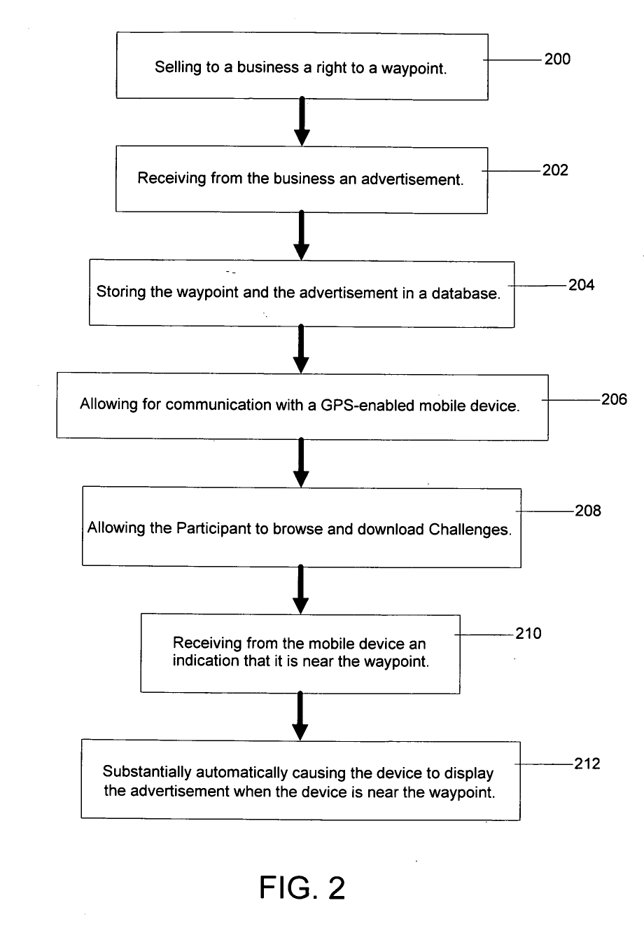

With reference to FIG. 2, in one exemplary application of the aforementioned embodiment, the method may comprise the following steps. The Service Provider sells to a business or group of businesses an advertising right to one or more waypoints, wherein each waypoint is associated with a particular geographic location, as shown in box 200.

The advertising right may be sold via an auction process, whereby the right is granted to the highest bidder. In one implementation of the auction process, the business may specify the one or more waypoints, and an amount, i.e., a budget, it is willing to spend to advertise for each waypoint or for the entire group of waypoints. When the Participant arrives at a waypoint, the business offering the most money to advertise, and which has not surpassed its specified budget, wins the auction.

Each waypoint or group of waypoints may be referred to as a “Challenge”. Challenges can be simple or difficult, long or short, less or more active, and stand-alone or related to a theme; may require Participants to complete waypoints in order, or complete specific waypoints on specific days or even at specific times; may reveal the next waypoint only after the current waypoint has been completed; or may require Participants to answer questions about waypoints before marking them as completed. Example Challenges include traveling to a series of historic sites, concerts, restaurants, national monuments, parks, or states or countries. For example, one Challenge may require the Participant to visit certain places within his or her town, while another Challenge may require the Participant to visit certain places all over the world.

Traveling to a waypoint may be referred to as “capturing” the waypoint. The manner in which a waypoint is captured may be part of the Challenge and may involve more than merely traveling to the waypoint. For example, as mentioned, a Challenge may require that waypoints be captured in a particular order, or require performance of some confirmational feat while at the waypoint, such as receiving and answering a question about the waypoint via the network.

The Service Provider receives from the business an advertisement to be associated with each waypoint, as shown in box 202. The Service Provider stores the waypoint and the advertisement in a database of waypoints and advertisements, as shown in box 204.

The Service Provider allows for bi-directional communication with a mobile location-determining device, such as a GPS-equipped cell phone, which is carried or otherwise associated with the Participant, as shown in box 206. The bi-directional communication may be wireless network, e.g., Internet, communication.

The Service Provider allows the Participant to download and install any necessary software onto the device, and then to browse and download one or more Challenges via the device, as shown in box 208. The method may further include the step of charging the Participant a fee for downloading the software onto the device. The Participant may be allowed to search the database of Challenges by area, type, or popularity. The downloaded Challenges become the “Active Challenges” that the Participant is working on. For each Active Challenge, the Participant may be able to display the one or more associated waypoints captured and/or the one or more associated waypoints yet to be captured.

The Service Provider receives from the mobile location-determining device an indication that the device is at the location or the waypoint, i.e., that the Participant has captured the waypoint, as shown in box 210. The Service Provider substantially automatically causes the device to display the advertisement when the device is within a specific number of feet of the geographic location, as shown in box 212.

The method may further include the step of charging the business a fee for each Participant who captures a waypoint and sees the business' advertisement. The method may further include the step of providing a hyperlink to additional information about the business.

The method may further include the step of rewarding the Participant for traveling to the waypoint. Potential rewards may include, prizes, redeemable points, or virtual “patches”. Patches may be graphical in nature and created by businesses or selected from a gallery of pre-created patches. Relatedly, the method may further include the step of assigning one or more points to the Participant for traveling to the waypoint, and maintaining point totals for all Participants, thereby facilitating competition among Participants to travel to more waypoints (and thereby see more advertising).

The method may further include the step of providing each Participant with a webpage on which to communicate such information as which Challenges he or she has completed, is currently engaged in, or is contemplating engaging in; his or her “patches”; and his or her point total.

The method may further include the step of allowing the Participant to rate completed Challenges and making the ratings accessible to other Participants via their devices, so that the other Participants contemplating engaging in those Challenges will have the benefit of the earlier Participant's experience.

By way of example and not limitation, the method may function substantially as follows. The Service Provider auctions to a business an advertising right to a series of waypoints. The business sells outdoor equipment, e.g., camping, hiking, and climbing equipment. The series of waypoints include relevant Challenges associated with national parks, well-known hiking trails, and well-known climbing sites. When the Participant arrives at the waypoint, the device reports its arrival to the Service Provider, and the Service Provider causes the device to display an advertisement by the business. Completing each Challenge requires that the Participant receive and answer via the Internet-enabled device a question about the waypoint. Upon doing so, the Participant is awarded a certain number of points, the accumulation of which entitles the Participant to a discount on his or her next purchase from the business. For the Participant's convenience, a hyperlink is provided to information about the business' nearest store locations and hours of operation.

By way of another example and not limitation, the method may function substantially as follows. The Service Provider sells to a municipality an advertising right to a series of waypoints. The municipality wishes to encourage both locals and tourists to visit the town's many businesses. The series of waypoints include relevant Challenges associated with historical sites, restaurants, stores, and other sites. When the Participant arrives at the waypoint, the device reports its arrival to the Service Provider, and the Service Provider causes the device to display an advertisement or message associated with the site. Completing each Challenge requires that the Participant make a purchase at the site. Upon doing so, the Participant is awarded a certain number of points based on the amount of the purchase (as reported to the Service Provider by an employee at the site), the accumulation of which entitles the Participant to a discount on his or her next purchase at any of the sites. For the Participant's convenience, a hyperlink is provided to information about the various sites.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A method comprising the steps of:
granting to an organization a right to a waypoint, wherein the waypoint is associated with a particular geographic location;
receiving from the organization a message to be associated with the waypoint;
storing the waypoint and the message in a database of waypoints and messages;
allowing for bi-directional data communication with a mobile device which is operable to determine its own geographic location;
receiving from the mobile device an indication that the device is at or near the particular geographic location associated with the waypoint; and
substantially automatically causing the device to display the message when the device is at or near the particular geographic location associated with the waypoint.

2. The method as set forth in claim 1, wherein the right to the waypoint is granted via a leasing arrangement.

3. The method as set forth in claim 1, wherein the right to the waypoint is granted via a sale arrangement.

4. The method as set forth in claim 3, wherein the sale arrangement involves an auction process, with the highest bidding organization winning the right to the waypoint.

5. The method as set forth in claim 1, wherein the device is a mobile cell phone operable to use a global positioning system to determine its own geographic location.

6. The method as set forth in claim 1, further including the step of charging the business a fee for each device on which the advertisement is caused to be displayed.

7. The method as set forth in claim 1, wherein the device is substantially automatically caused to display the message when the device is within a particular number of feet from the particular geographic location of the waypoint.

8. The method as set forth in claim 1, further including the step of providing a hyperlink to additional information about the organization or the particular geographic location associated with the waypoint.

9. The method as set forth in claim 1, further including the step of rewarding a user of the device for traveling to the waypoint.

10. The method as set forth in claim 9, further including the step of assigning one or more points to the user for traveling to the waypoint, and maintaining point totals for all such users.

11. The method as set forth in claim 10, further including the step of providing each user with a webpage on which to communicate the user's point total.

12. A method comprising the steps of:
auctioning to a business an advertising right to a waypoint, wherein the waypoint is associated with a particular geographic location;
receiving from the business an advertisement to be associated with the waypoint;
storing the waypoint and the advertisement in a database of waypoints and advertisements;
allowing for bi-directional data communication with a mobile device which is operable to determine its own geographic location;
receiving from the mobile device an indication that the device is at or near the particular geographic location associated with the waypoint; and
substantially automatically causing the device to display the advertisement when the device is at or near the particular geographic location associated with the waypoint.

13. The method as set forth in claim 12, wherein the device is a mobile cell phone operable to use a global positioning system to determine its own geographic location.

14. The method as set forth in claim 12, further including the step of charging the business a fee for each device on which the advertisement is caused to be displayed.

15. The method as set forth in claim 12, further including the step of providing a hyperlink to additional information about the business.

16. The method as set forth in claim 12, further including the step of rewarding a user of the device for traveling to the waypoint.

17. The method as set forth in claim 16, further including the step of assigning one or more points to the user for traveling to the waypoint, and maintaining point totals for all such users.

18. The method as set forth in claim 17, further including the step of providing each user with a webpage on which to communicate the user's point total.

19. A method of advertising using waypoint, wherein an advertisement is substantially automatically displayed on a mobile cell phone operable both to access the Internet and to use global positioning system technology to determine its own geographic location, the method comprising the steps of:
auctioning to a business an advertising right to a waypoint, wherein the waypoint is associated with a particular geographic location;
receiving from the business an advertisement to be associated with the waypoint;
storing the waypoint and the advertisement in a database of waypoints and advertisements;
allowing for bi-directional data communication via the Internet with the mobile cell phone;
receiving from the mobile cell phone an indication that the mobile cell phone is at or near the particular geographic location associated with the waypoint;
substantially automatically causing the mobile cell phone to display the advertisement when the mobile cell phone is at or near the particular geographic location associated with the waypoint;
charging the business a fee for each mobile cell phone on which the advertisement is caused to be displayed;
providing a hyperlink to additional information about the business; and
rewarding a user of the mobile cell phone for traveling to the waypoint.
